(19) United States
(12) Patent Application Publication
(10) Pub. No.: US 2019/0223394 A1
(43) Pub. Date: Jul. 25, 2019

(54) Method and Apparatus for Reducing Urban Runoff Through Intelligent Automated Rainwater Collection

(71) Applicants: Jordan Sun Labio, Saratoga, CA (US); Dustin Miao, Saratoga, CA (US); Kabir Ramzan, Saratoga, CA (US)

(72) Inventors: Jordan Sun Labio, Saratoga, CA (US); Dustin Miao, Saratoga, CA (US); Kabir Ramzan, Saratoga, CA (US)

(21) Appl. No.: 16/256,106

(22) Filed: Jan. 24, 2019

Related U.S. Application Data
(60) Provisional application No. 62/621,517, filed on Jan. 24, 2018.

(51) Int. Cl. A01G 25/16; G05D 7/06; B05B 12/08

(52) U.S. Cl. CPC A01G 25/16; B05B 12/081; G05D 7/0676; G05D 7/0635

(57) ABSTRACT

The present invention relates to the collection of water and more specifically to the collection of rainwater. A challenge in rainwater collection is to minimize manual effort and operator inconvenience. Existing methods in the art do not gracefully handle situations in which insufficient rainwater is collected. Existing methods also require manual retrieval of collected rainwater. Accordingly, we present novel methods, components, and systems for automatically and intelligently collecting and using rainwater. More specifically, we describe methods, components, and systems for integrating rainwater collection systems with main line water sources and drip systems using a programmable controller that can direct water flow from the appropriate source using programmable logic that takes inputs from a plurality of sources, possibly comprising, but not limited to, the level of collected water and the parameters of the irrigation controller. The disclosed invention provides a significant improvement with regard to efficiency and ease of use compared to prior art.

### CROSS REFERENCE TO RELATED APPLICATION AND BENEFIT OF PRIORITY

The present disclosure is related to, and claims benefit to, U.S. Provisional Patent Application Ser. No. 62/621,517, entitled “Method and Apparatus for Reducing Urban Runoff Through Intelligent Automated Rainwater Collection,” which was filed on Jan. 24, 2018, the entirety of which is incorporated by reference into the present disclosure.

### FIELD OF THE INVENTION

The present invention relates to the collection of water and more specifically to collection of rainwater through a method and apparatus for intelligent automated rainwater collection.

### BACKGROUND OF THE INVENTION

It is known in the art that urban runoff from storm water is a significant environmental issue. Storm water runoff carries garbage and pollutants such as oil, dirt, metals, soap, fertilizers, and other chemicals directly to streams, rivers, oceans, and other bodies of water. Consequently, water quality is harmed and wildlife can be killed. Storm further water causes erosion and floods, which can damage property and further harm aquatic life. It is also known in the art that in an average household, outdoor landscaping accounts for significant water usage. Therefore, reducing outdoor water usage can have a dramatic impact in households.

One popular technique in the art for reducing urban runoff from storm water and reducing external water usage for landscaping is to use a rain barrel collection system, which works as follows.
a. A container or similar apparatus is placed in a location where water pours from a roof during a rain storm. One such location known in the art is a down spout from a rain gutter.
b. Water from the down spout (or other specified location where rain water pours from a roof during a storm) is directed into the container.
c. The container collects and stores rain water.
d. The container has a controllable output mechanism where the collected rainwater can be utilized. For example, a hose can be connected to the output mechanism and the collected rain water can be used for landscaping.

One issue with the above approach is that rainwater collection is non-uniform. Periods of rain may be followed by many days with no rain. Therefore, the rain barrel may not have collected sufficient water for use in landscaping. Another limitation of rain barrels is that the user typically has to manually retrieve the water for usage. Accordingly, the user of the rain barrel is inconvenienced and may cease using the rain barrel altogether.

There is, accordingly, a need in the art to develop methods, components, and systems for collecting rainwater through intelligent and automated means that do not inconvenience the user and enable seamless use of rain barrels. It is therefore an object of the present invention to address this issue through the integration of rain barrel collection systems with automated irrigation systems (in particular drip systems) as well as main line water sources together with an automated and intelligent mechanism for identifying which water source to use.

### SUMMARY OF THE INVENTION

In summarizing the invention, a system-level view is given, and then the components comprising that system as well as the methods to be executed on those components are described. It is to be understood that in addition to the overall system, the invention being disclosed also comprises the individual underlying components used in the system as well as the individual methods that would be executed on those components.

According to one aspect of the present invention, a system is provided that integrates rain collection and irrigation systems, specifically drip systems. The system comprises the following: a plurality of rain barrels that are connected together; a mechanism for monitoring the water level in the barrels (such as, but not limited to, a float switch); a controllable valve attached to the main water line; a controllable valve attached to the rain barrel output; an optional water pump attached to the rain barrel output should there be insufficient pressure to draw the water out of the barrel; a three-way junction that connects the main line and rain barrel to the drip system; a controller apparatus that receives inputs from the water level monitoring mechanism (e.g., float switch) as well as the drip system collector and determines which source the drip system should use when water is needed. The system operates as follows. The rain barrels are connected together. The monitoring mechanism is used to determine whether there is sufficient water in the rain barrels. Controllable valves are attached to the main line and rain barrel outputs. Optionally, a water pump can be attached to the rain barrel output prior to the controllable valve should water pressure be insufficient. The outputs of the controllable valves are connected to a three-way junction that feeds the drip system. The controller apparatus receives inputs from the water level monitoring mechanism (e.g., float switch) and the drip system controller. When the drip system needs water, the controller can determine which source to use. In particular, if there is sufficient water in the barrel (as determined by the water level monitoring mechanism), the controller opens the rain barrel valve and keeps the main line valve closed. In this case, the drip system uses water from the rain barrel. If, however, there is insufficient water in the rain barrel (as determined by the input received from the water level monitoring mechanism) the controller opens the valve attached to the main line and keeps the valve attached to the rain barrel closed. Accordingly, the drip system has access to water even if the rain barrels are not sufficiently filled.

According to one aspect of this invention is a component comprising a plurality of water storage mechanisms that can receive water from an external source (e.g., rain water) and can that can be connected to a main line. The water level of these barrels can be monitored.

According to another aspect of this invention is a component that monitors whether the water level in a water storage mechanism are above a certain threshold and is capable of communicating this information to another component.

According to another aspect of this invention is a valve that can be controlled by a controller mechanism that is attached to the output line of a water storage mechanism for the purpose of controlling whether to output water from the water storage mechanism.

According to another aspect of this invention is a valve that is attached to the output line of a water storage mechanism and that can be controlled by a controller mechanism for the purpose of controlling whether and how much water should be used from the water storage mechanism possibly in conjunction with a plurality of other water sources.

According to another aspect of this invention is a valve that is attached to the output line of a main line water source and that can be controlled by a controller mechanism for the purpose of controlling whether and how much water should be used from the main line water source possibly in conjunction with a plurality of other water sources.

According to another aspect of this invention is a multi-way junction that connects a plurality of water sources possibly including, but not limited to, a main line water source and a water storage mechanism, to a drip system where the choice of which water sources to obtain water from can be controlled by programmable logic.

According to another aspect of this invention is a controller that can receive inputs, possibly including, but not limited to a water level monitoring mechanism, a drip system collector, and applies programmable logic to control controllable valves.

According to another aspect of the present invention, the output of the three-way junction can be fed to systems other than drip systems for which water usage may be needed.

According to another aspect of the present invention, the output of the three-way junction can be fed to a plurality of other systems, with the flow dictated by controllable valves and the choice of system dictated by programmable logic.

According to another aspect of the present invention, a plurality of filtration methods can be applied to the plurality of systems connected to the three-way junction. used for different use cases, including, but not limited to, drinking water, laundry, landscaping, or toilets. For each such use case, separate downstream treatment components can be used to process the water for the appropriate application, such as using strong water filtration methods for drinking water or bypassing filtration altogether for waste water use cases.

According to another aspect of the present invention, additional logic in the multiplexing controller apparatus can be incorporated, including, but not limited to, decision making logic for which water sources to employ based on alternate input signals, such as the current time or date or the current aggregate water usage during a specified time period. This variation provides benefit if the cost of water usage can vary and it may be more advantageous to use main line water when it is less cost prohibitive.

According to another aspect of the present invention, a method is provided for determining how to control a set of controllable valves based on external inputs, which can include, but are not limited to, a water level monitoring component. The method is carried out by processing logic that may comprise hardware (e.g., circuitry, dedicated logic, etc.), software (such as is run on a general purpose computer system or a dedicated machine), or a combination of both. It is to be understood, however, that the choice of where and how the method is performed is not to be limited by the present description, and it should be apparent to a person of ordinary skill in the art that many such choices exist.

### DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

The subsequent description of the preferred embodiments of the present invention refers to the attached drawings, wherein:

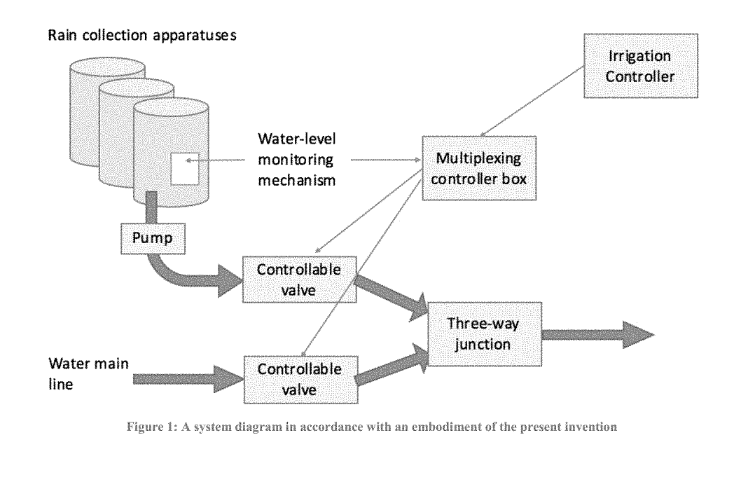

a. FIG. 1: A system diagram in accordance with an embodiment of the present invention.

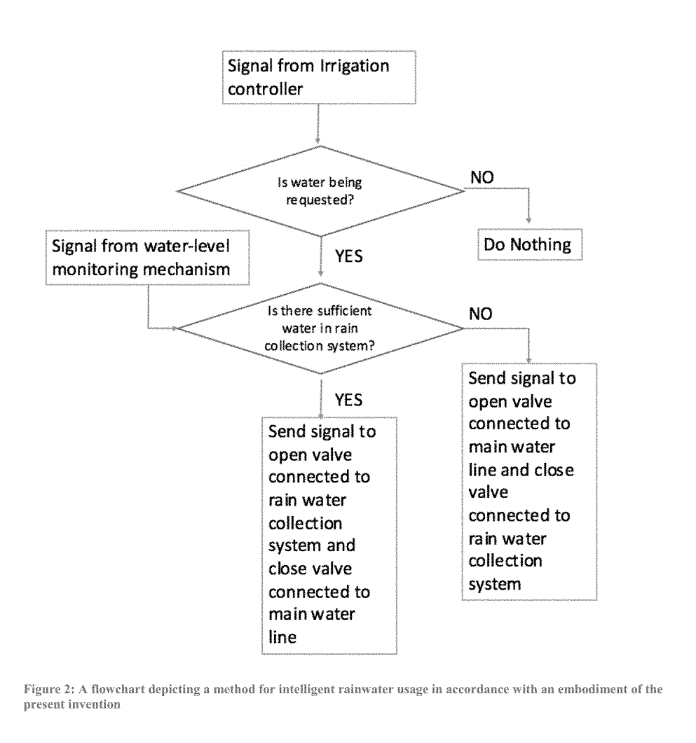

b. FIG. 2: A flowchart depicting a method for intelligent rainwater usage in accordance with an embodiment of the present invention.

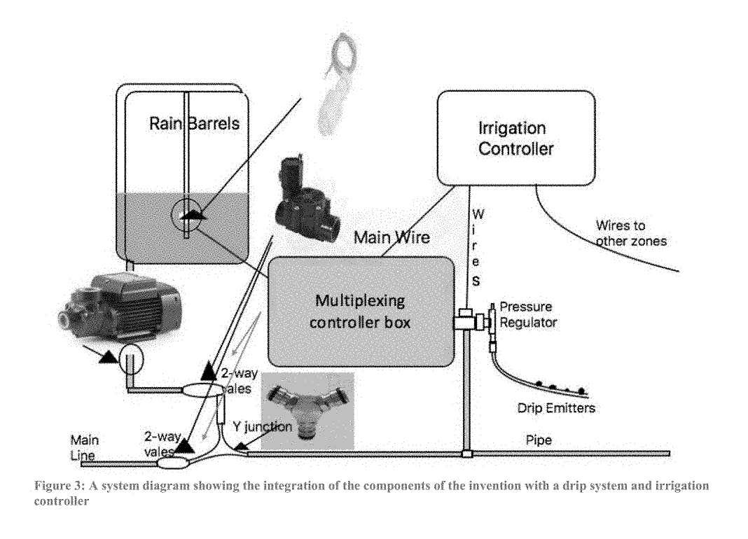

c. FIG. 3: A system diagram showing the integration of the components of the invention with a drip system and irrigation controller.

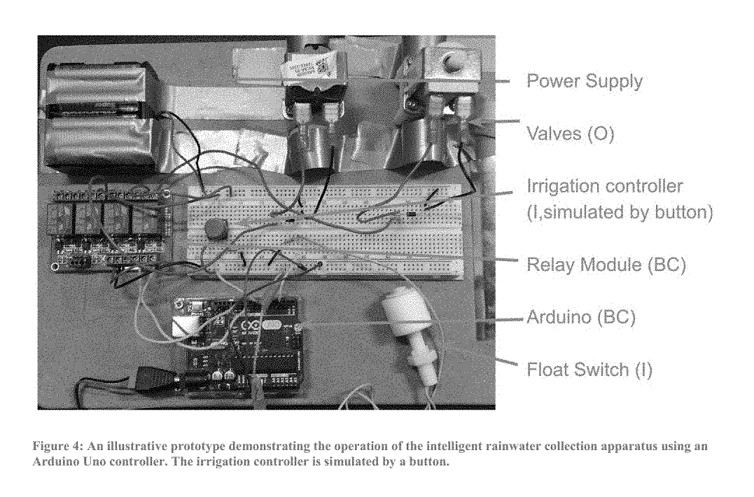

d. FIG. 4: An illustrative prototype demonstrating the operation of the intelligent rainwater collection apparatus using an Arduino Uno controller. The irrigation controller is simulated by a button.

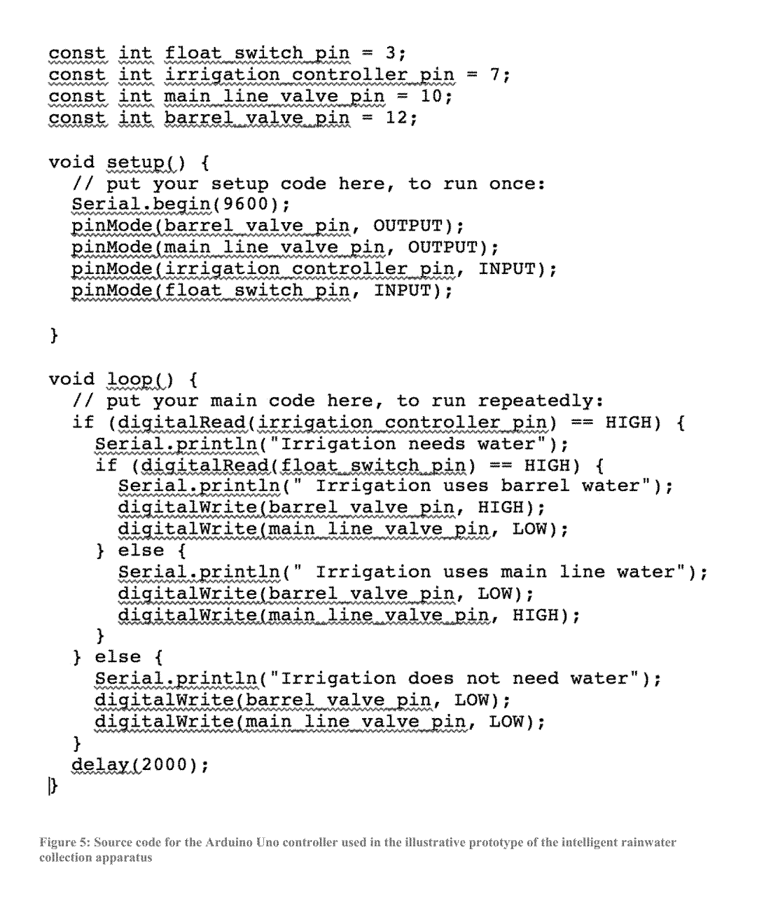

e. FIG. 5: Source code for the Arduino Uno controller used in the illustrative prototype of the intelligent rainwater collection apparatus.

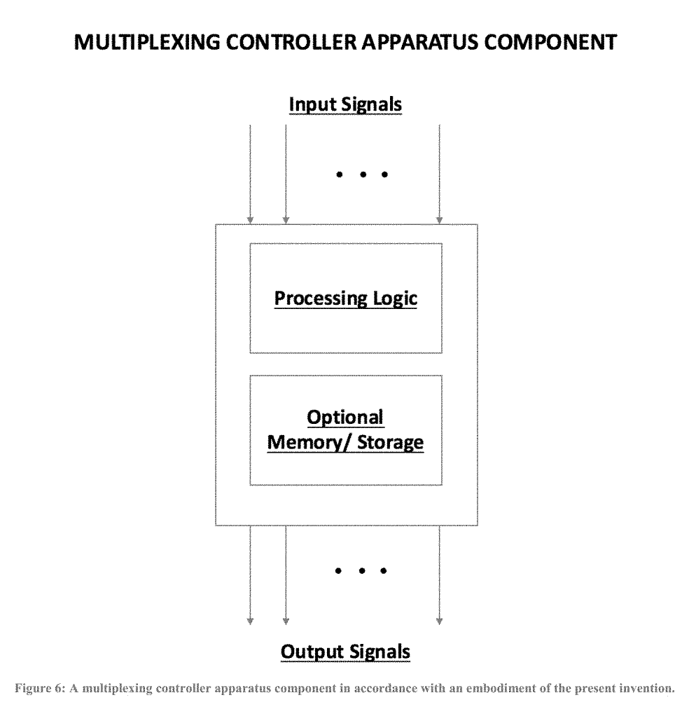

f. FIG. 6: A multiplexing controller apparatus component in accordance with an embodiment of the present invention.

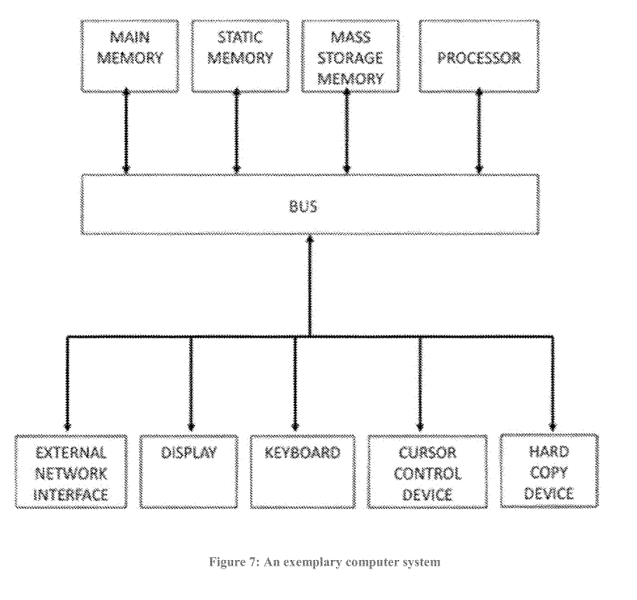

g. FIG. 7: An exemplary computer system.

### DETAILED DESCRIPTION OF THE INVENTION

In the following description, numerous details are set forth to provide a more thorough explanation of the present invention. It will be apparent, however, to one of ordinary skill in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These descriptions and representations are the means used by those skilled in the data processing arts to most effectively convey the substance of their work to others skilled in the art. The steps described herein are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, solid-state disk drives, read-only memories (ROMs), random access memories (RAMs), EPROMs, EEPROMs, magnetic or optical cards, or any type of media suitable for storing electronic instructions, and each coupled to a computer system bus.

The descriptions presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein. A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

The description that follows will reference terminology that is generally known in the art.

A water level monitoring mechanism is a component that can determine whether the level of water or similar liquid in a container, tank, or similar apparatus is below a specific threshold. One mechanism known in the art for monitoring liquid level is float switch. It is known in the art that a float switch can be used as an indicator or an alarm. It is similarly known in the art that the switch can be used to control a pump or other device. A rain collection apparatus is an apparatus that can capture water from a source, such as a roof. A rain collection apparatus can further store that water for later use. Some uses in the art include watering lawns, general gardening, or watering indoor plants. A rain collection apparatus further has an output mechanism that is used to facilitate disseminating stored liquids for these uses. It is known in the art that through a rain collection apparatus, water from roof runoff can be collected, which in turn reduces the quantity of water that flows from a given property. It is known in the art that a plurality of rain collection apparatuses can be connected to each other. One rain collection apparatus known in the art is a rain barrel. Irrigation Systems are known in the art for controlling the use of water for applications, such as watering plants. Irrigation system can control the amount of water disseminated and can typically be designed to work at specified intervals. One example of an irrigation system in the art is a drip irrigation system. A drip irrigation system operates at low pressure and controls low volumes of water, typically for lawns, gardens, and other home landscapes. The mechanisms by which drip irrigation systems disseminate water include, but need not be limited to, drip, spray, or stream. Underground sprinkler systems and lawn sprinklers are other examples of irrigation systems known in the art. This invention can be practiced with any choice of irrigation system. An irrigation system typically has an irrigation system controller, which can send signals to the irrigation system to specify and control its operations. Similarly, it is known in the art that a drip system has a drip system controller. A controllable valve is a valve known in the art that can be used to control the flow of fluid. Controllable valves typically work by changing the size of the passage through which the liquid flows, as specified in accordance to a signal issued by a controller. A three-way junction is an apparatus known in the art with two input sources for liquids and one output source. It can be used to facilitate choosing one liquid source. A water main is a pipe or similar apparatus that is connected to a substantial water source, such as the public water supply. The water main helps transport water from this source.

According to one aspect of the present invention, a system is provided that integrates a plurality of rain collection apparatuses with irrigation systems. The system comprises the following components: a plurality of rain collection apparatuses that are connected together, such that the output of one feeds into another, with one remaining rain collection apparatus whose output is not connected to another such apparatus; a water level monitoring mechanism; a controllable valve attached to the water main; an optional water pump attached to the output of the rain collection apparatuses; a controllable valve attached to either the output of the water pump or to the output of the remaining rain collection apparatus; a three-way junction that connects the water main and rain collection apparatus to the irrigation system; a multiplexing controller apparatus that receives inputs from the water level monitoring mechanism as well as the irrigation system controller and determines which source the irrigation system should use when water is needed. The system operates as follows. The plurality of rain collection apparatuses are connected together. The water level monitoring mechanism is used to determine whether there is sufficient water in the rain collection apparatuses. Controllable valves are attached to the water main and outputs of the rain collection apparatuses. The outputs of these controllable valves is connected to a three-way junction that feeds the irrigation system. The multiplexing controller apparatus receives inputs from the water level monitoring mechanism and the irrigation system controller. When the irrigation system needs water, the multiplexing controller apparatus can determine which source to use. In particular, if the water level monitoring mechanism determines that there is sufficient water in the rain collection apparatuses, the multiplexing controller apparatus opens the controllable valve connected to the rain collection apparatus and keeps the controllable valve connected to the water main closed. In this case, the irrigation system uses water from the rain collection apparatuses. If, however, the water level monitoring mechanism indicates that there is insufficient water in the rain collection apparatuses, the multiplexing controller apparatus opens the controllable valve attached to the water main and keeps the controllable valve attached to the rain water collection apparatuses closed. Accordingly, the irrigation system has access to water main even if the rain water collection apparatuses are not sufficiently filled.

According to another aspect of this invention, a multiplexing controller apparatus component is provided that can execute the following steps: First, the multiplexing controller apparatus receives inputs from the water level monitoring mechanism and the irrigation system controller. Second, when the irrigation system controller sends a signal that water is needed, the multiplexing controller executes the following logic to determine which source to use. If the water level monitoring mechanism determines that there is sufficient water in the rain collection apparatuses, the multiplexing controller apparatus opens the controllable valve connected to the rain collection apparatus and keeps the controllable valve connected to the water main closed. In this case, the irrigation system uses water from the rain collection apparatuses. Otherwise, if the water level monitoring mechanism indicates that there is insufficient water in the rain collection apparatuses, the multiplexing controller apparatus opens the controllable valve attached to the water main and keeps the controllable valve attached to the rain water collection apparatuses closed. Accordingly, the irrigation system has access to water main even if the rain water collection apparatuses are not sufficiently filled.

FIG. 7 is a block diagram of an exemplary computer system that may perform one or more of the operations described herein. Referring to FIG. 7, the computer system may comprise an exemplary client or server computer system. The computer system comprises a communication mechanism or bus for communicating information, and a processor coupled with a bus for processing information. The processor includes a microprocessor, but is not limited to a microprocessor, such as, for example, Pentium, PowerPC, Alpha, ARM, etc. The system further comprises a random access memory (RAM), or other dynamic storage device (referred to as main memory) coupled to the bus for storing information and instructions to be executed by the processor. Main memory also may be used for storing temporary variables or other intermediate information during execution of instructions by the processor.

The computer system also comprises a read only memory (ROM) and/or other static storage device coupled to the bus for storing static information and instructions for the processor, and a data storage device, such as a magnetic disk or optical disk and its corresponding disk drive. The data storage device is coupled to the bus for storing information and instructions. The computer system may further be coupled to a display device, such as a cathode ray tube (CRT) or liquid crystal display (CD), coupled to the bus for displaying information to a computer user. An alphanumeric input device, including alphanumeric and other keys, may also be coupled to the bus for communicating information and command selections to the processor. An additional user input device is cursor control, such as a mouse, trackball, trackpad, stylus, or cursor direction keys, coupled to the bus for communicating direction information and command selections to the processor, and for controlling cursor movement on the display. Another device that may be coupled to the bus is a hard copy device, which may be used for printing instructions, data, or other information on a medium such as paper, film, or similar types of media. Furthermore, a sound recording and playback device, such as a speaker and/or microphone may optionally be coupled to the bus for audio interfacing with the computer system. Another device that may be coupled to the bus is a wired/wireless communication capability to communication to a phone or handheld palm device.

Note that any or all of the components of the system and associated hardware may be used in the present invention. However, it can be appreciated that other configurations of the computer system may include some or all of the devices.

### Example 1

This example illustrates a specific instance of the invention, describing the steps and actions along the way. This example is provided to help clarify the description, and it should not be considered limiting in any way. For example, the above invention description covers many variations and extensions. To avoid obscuring the example, these variations and extensions are not discussed below.

A plurality or rain barrels are connected together, so that the output of one barrel flows into the input of another. In this manner, if one of the barrels overflows, the barrel to which it is connected will be filled. One barrel's output will not be connected to another barrel. This barrel will be referred to as the remaining barrel.

The output of the remaining barrel is connected to a controllable valve. The output of the main line water system is connected to a controllable valve. The output of the two controllable valves are connected to a three-way junction that feeds the drip system.

A float switch is placed in the remaining barrel. In this manner, the float switch can serve to indicate whether the aggregate collected water in the barrels is below a threshold.

A multiplexing controller apparatus receives signals from a plurality of sources, including, but not limited to an irrigation controller, which indicates whether there is a need for water such as by a drip system, and also from the float switch to indicate whether there is adequate water in the rain barrels.

The multiplexing controller can send signals to the controllable valves to indicate whether they should be opened or closed.

The multiplexing controller apparatus can be implemented using an Arduino Uno, or similar apparatus, or can be custom built.

If the signal from the float switch indicates that there is sufficient water, the multiplexing controller apparatus sends a signal to the controllable valve connected to the rain barrels to have it open, and sends a signal to the controllable valve connected to the main line water system to have it close. In this manner, when there is sufficient water in the barrels, the three-way junction receives water from the barrel system.

If the signal from the float switch indicates that there is insufficient water in the barrels, the multiplexing controller apparatus sends a signal to the controllable valve connected to the rain barrels to have it close, and sends a signal to the controllable valve connected to the main line water system to have it open. In this manner, when there is insufficient water in the barrels, the three-way junction receives water from the main line system.

The resulting output flow of water can be used by the irrigation system.

It should be apparent to one of ordinary skill in the art that some of these operations can be performed in different order. For example, the multiplexing controller apparatus can have the valves in the appropriate positions before a request for water is made by the irrigation system.

Whereas many alterations and modifications of the present invention will no doubt become apparent to a person of ordinary skill in the art after having read the foregoing description, it is to be understood that any particular embodiment shown and described by way of illustration is in no way intended to be considered limiting.

What is claimed is:

1. An automated rainwater collection and dispensing system comprising:
a rainwater collection system, wherein the rainwater collection system further comprises a water level monitoring mechanism;
a multiplexing controller box, the multiplexing controller box configured to, based upon input from the water level monitoring mechanism and an irrigation controller, adjust a first controllable valve and a second controllable valve to control an amount to water to dispense for irrigation,
wherein the first controllable valve controls the output flow of water from the rainwater collection system, and
wherein the second controllable valve controls the output flow of water from a water mainline; and
a junction that connects the output flow from the first controllable valve and the output flow from second controllable valve to dispense water for irrigation to one or more areas.

2. The automated rainwater collection and dispensing system of claim 1, wherein upon receiving a signal from the irrigation controller to begin watering, the multiplexing controller box detects a low level of water from the water level monitoring mechanism and adjusts the first controllable valve to close output flow, and adjusts the second controllable valve to open output flow.

3. The automated rainwater collection and dispensing system of claim 1, wherein upon receiving a signal from the irrigation controller to begin watering, the multiplexing controller box detects a high level of water from the water level monitoring mechanism and adjusts the first controllable valve to open output flow, and adjusts the second controllable valve to close output flow.

4. The automated rainwater collection and dispensing system of claim 1, wherein the irrigation controller sends a signal to begin watering to the multiplexing controller box based upon a particular time interval.

5. The automated rainwater collection and dispensing system of claim 1, wherein the multiplexing controller is configured to output to a user interface a source of the dispensed water to the one or more areas.

6. The automated rainwater collection and dispensing system of claim 1, wherein the rainwater collection system comprises one or more rainwater collection barrels.

7. The automated rainwater collection and dispensing system of claim 1, wherein the rainwater collection system comprises a pump that pushes water from the rainwater collection barrels to the first controllable valve to output the flow of water.

8. The automated rainwater collection and dispensing system of claim 1, wherein the water level monitoring mechanism is a float switch.

9. The automated rainwater collection and dispensing system of claim 1, wherein the multiplexing controller box is an Arduino Uno.

10. The automated rainwater collection and dispensing system of claim 1, wherein the junction is connected to a drip irrigation system for dispensing to one or more areas.

11. The automated rainwater collection and dispensing system of claim 1, wherein the junction is connected to an underwater sprinkler system for dispensing to one or more areas.
